(19) United States
(12) Patent Application Publication
(10) Pub. No.: US 2017/0278181 A1
(43) Pub. Date: Sep. 28, 2017

(54) SYSTEM AND METHOD FOR PROVIDING FINANCIAL ASSISTANT

(71) Applicant: Rajan Shah, Yardley, PA (US)

(72) Inventor: Rajan Shah, Yardley, PA (US)

(21) Appl. No.: 15/466,763

(22) Filed: Mar. 22, 2017

Related U.S. Application Data
(60) Provisional application No. 62/313,000, filed on Mar. 24, 2016.

(51) Int. Cl. G06Q 40/00; G06Q 10/06

(52) U.S. Cl. CPC G06Q 40/00; G06Q 10/067

(57) ABSTRACT

The present disclosure describes a system for providing personalized financial recommendation based on user-specific attributes and predetermined historical financial projections. This engine collects various user preferences, user behavior, and predictions from prediction engine as well as market dynamics to recommend various ideas to user. An intelligent financial assistant is capable of Natural Language dialog by identifying contextual meanings of the user's queries and relating financial sub-domain. It learns from user's context, behavioral patterns to generate unique recommendations pertaining to their situations. These dynamic personalized recommendations can take different shape based on usage patterns and can be a trading idea, financial advice, suggestion, tax advice, or even investment tips.

### BACKGROUND

Field of the Invention

The subject matter described herein relates generally to information technology. More specifically, the present disclosure is related to data aggregation and classification techniques for providing personalized financial recommendations.

Description of Related Art

Today's financial advisory systems cover very narrow domain including personal information, demographics. It doesn't capture user's role transition throughout the day, weeks, months or years. It also doesn't capture user's surroundings such as user's friends, colleagues or others.

In particular, today's busy world user needs to pay attention to several information sources at a time to capture relevant and material information to act on it.

In addition, user needs to pay attention to various relations or analytically evaluate them to keep an eye on useful information from their social media, news feeds, economic events and/or world events.

In competitive world, user would like to stay on top of legendary investors to learn from their behavior and replicate their performance.

Often, each application, function, website or feature has its own user interface. User needs to visit these distinct web-sites fill out details. When user needs piece of information or needs to keep tab on certain information component they need to visit several web sites. In addition, user needs to collect various financial data, clean data and analyze data before getting required piece of information.

Also, to maintain their lead over others users would like to compete with friends and family members for fun and satisfaction.

In particular, busy financial individuals such as Trader, Financial Advisor, Portfolio Manager, Risk Manager, etc. . . . who are dealing with multiple information sources and voluminous information throughout the day. Such users always have difficulty in obtaining key information from overwhelming interfaces that prevent them from being productive.

At the same time, user who is financially savvy and would like to keep up with his or her finances need to visit one or more brokerage web sites to find out “How their 401k is doing” or “Whether they've sufficient fund within their 529 account” or even “Whether there will be enough retirement funds when they will retire”? There is no one such system, which comprehensively integrates various brokerages, analyze user's needs based on demographics or financial condition and provide much needed recommendation.

The present invention is an intelligent automated financial assistant system engages user based on their persona and context in an integrated, conversational manner using natural language dialogs, and invokes internal/external services based on various actions. The system can be implemented using platforms such as Web, Smartphone or Tablet and the like, or any combination thereof.

### BRIEF DESCRIPTION OF THE DRAWINGS

FIG. 1 describes high-level internal architecture of Intelligent Automated Financial Assistant.

FIG. 2 depicts user interaction with Intelligent Automated Financial Assistant as it allows user choice of answers one of the questions by user.

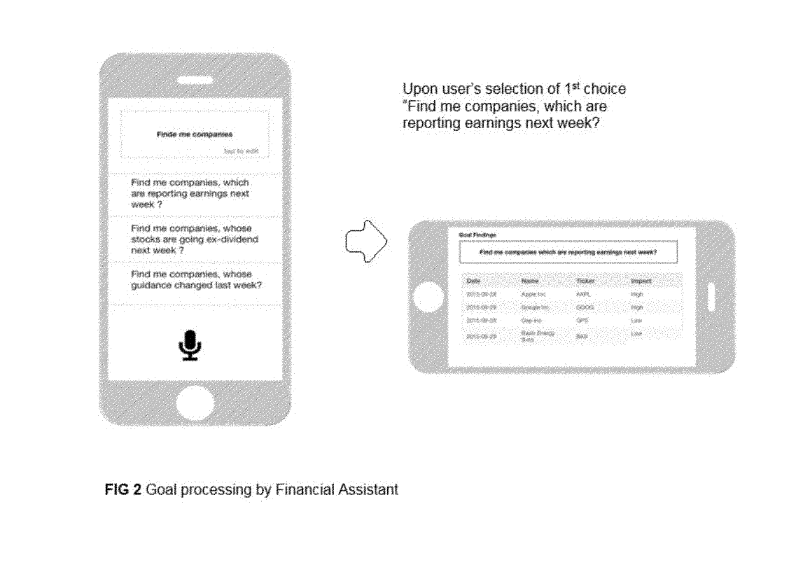

FIG. 3 depicts user interaction with Intelligent Automated Financial

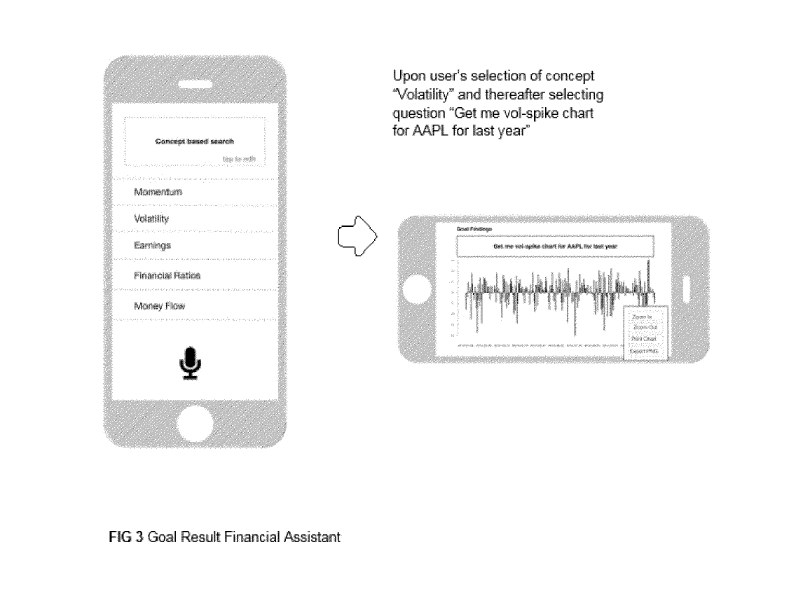

Assistant as it allows user to search by concept. Upon search by concept, user will be presented questions pertaining to the concept and user will be allowed to select from one of these questions.

FIG. 4 illustrates the overall system architecture of Intelligent Automated Financial Assistant. It highlights key components of the system such as Compute Engine, Financial Services, Pub/Sub component (to publish/subscribe real-time notifications), Brokerage services (to retrieve user's financial holdings and transactions) and Price feed (to retrieve real-time/historical price information about various instruments).

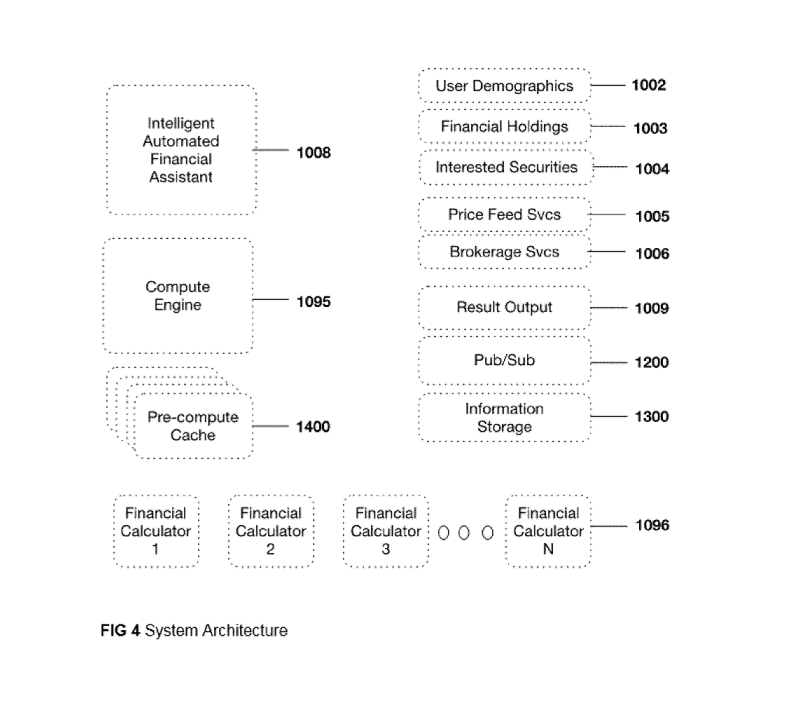

FIG. 5 displays News Aggregator internal architecture. It highlights the inner working of news aggregator. First, it collects news feeds from structured/unstructured media. It than performs semantic analysis on top of news story to extract key concepts. As a next step in pipeline, it calculates sentiment for these news stories to determine overall sentiment. Thereafter news aggregator aggregates news every N minutes by specific category (people, place, security, topic, etc. . . . ) to generate various measures at aggregate level.

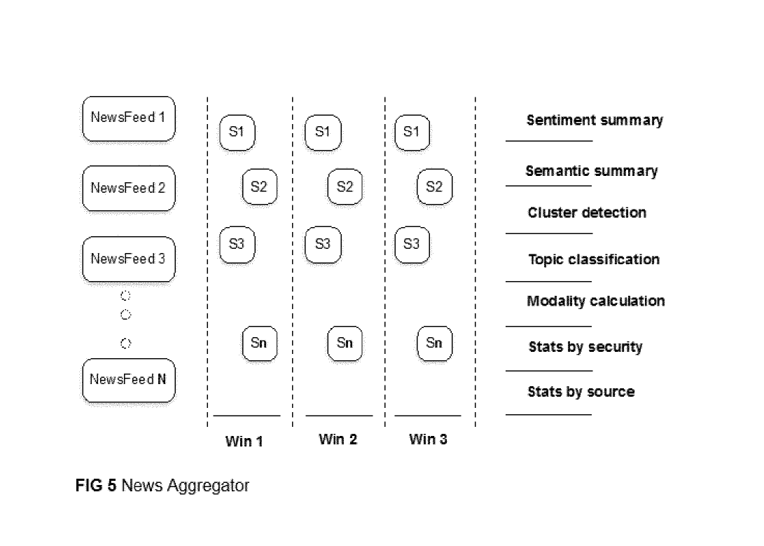

FIG. 6 displays overall flow of portfolio optimization request and its internal components such as user demographics, financial holdings and risk preferences shape up overall optimization request.

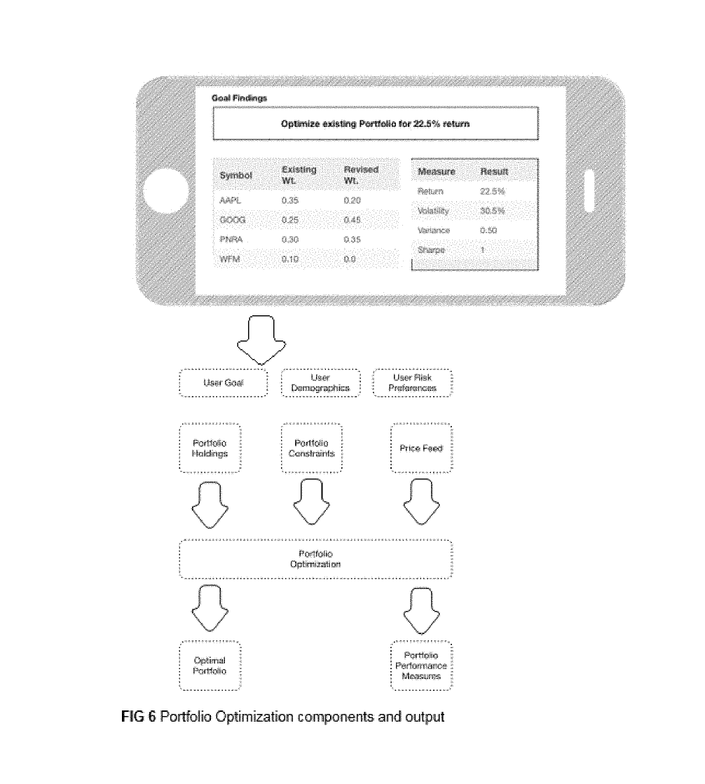

FIG. 7 illustrates overall flow of generic asset allocation request and its internal asset allocation engine workflow. Based on user's demographics, risk preferences and existing allocation the engine recommends allocation.

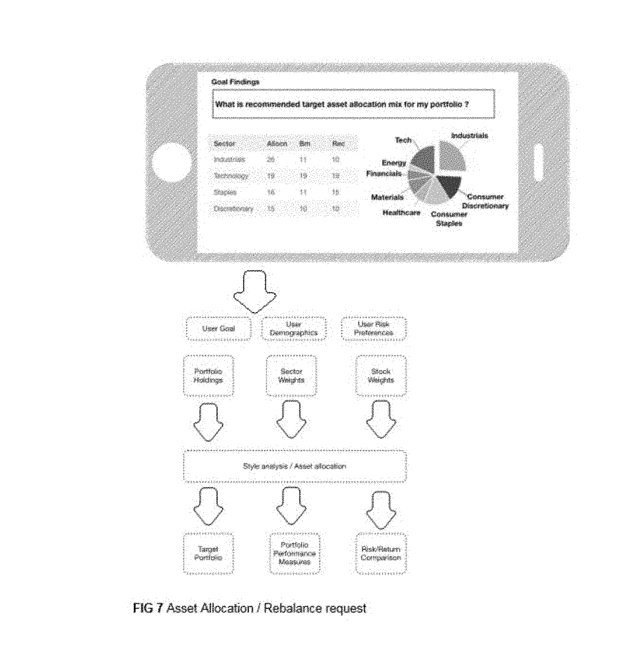

FIG. 8 describes overall system architecture in detail and its interaction with key components. Web, Mobile and other similar networked appliances can connect to IntelliMind REST server which allows interaction with Price Feed server, News Aggregation services, External services (for ex. Brokerage, etc. . . . )

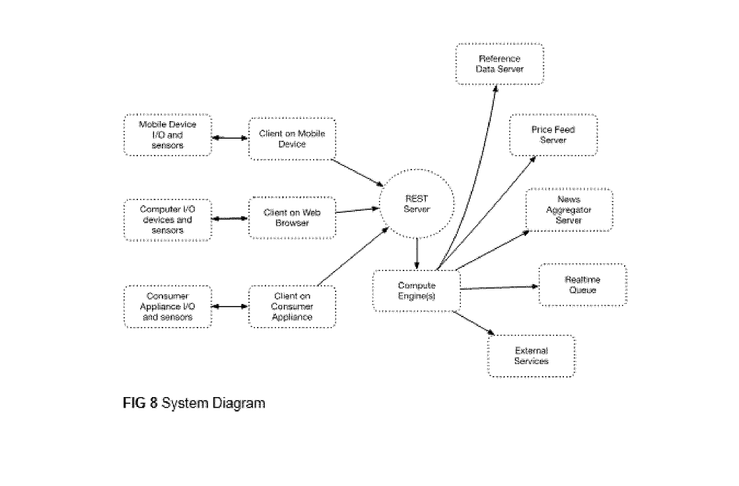

FIG. 9 describes goal sentence completion and potential selection. It captures active user input, speech to text conversion, semantic relevance based goal scoring and displaying sentences with top-matching scores above threshold. If there is only one matching goal, the system automatically selects it on behalf of user otherwise; it will present multiple choices to user for potential selection.

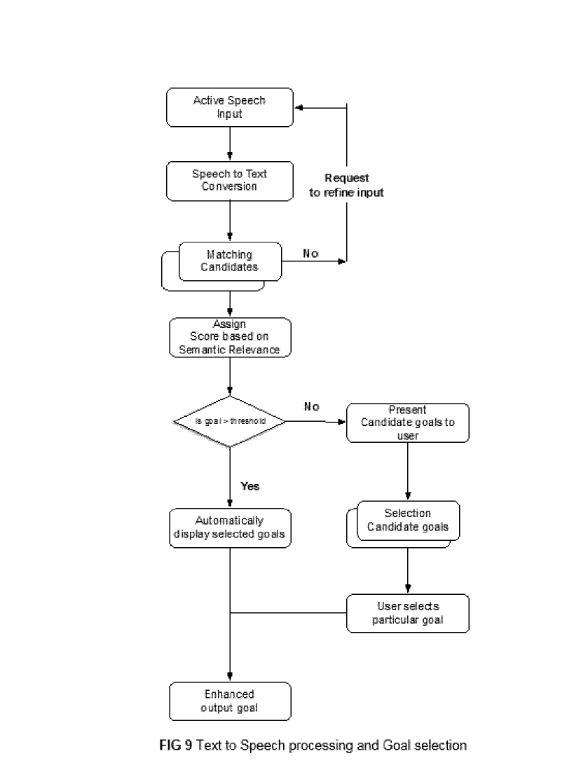

FIG. 10 depicts workflow, where system utilizes Natural Language understanding techniques to capture user intent. Based on domain specific concept pattern recognition, domain specific vocabularies, synonyms and active learning the system will capture the “user intent” from the goal. It further enhances captured intent by domain specific modeling and facts database to generate necessary “intent template” with action and constraint information.

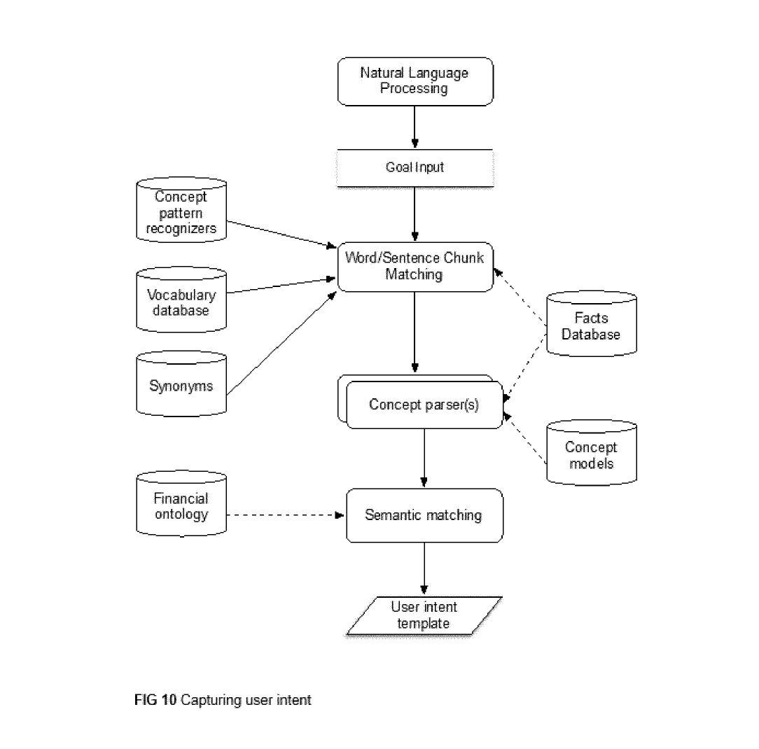

FIG. 11 displays control flow diagram, which classifies captured user intent by financial sub-domain specific categories. This allows system to automatically fine-tune various measures and constraints. As a result, compute-engine uses template to invoke specific Financial Service/Financial Calculate to evaluate the template to generate relevant answer. Output processor can further transform this output to match device specific needs. Output enhancer personalizes output based on user preferences.

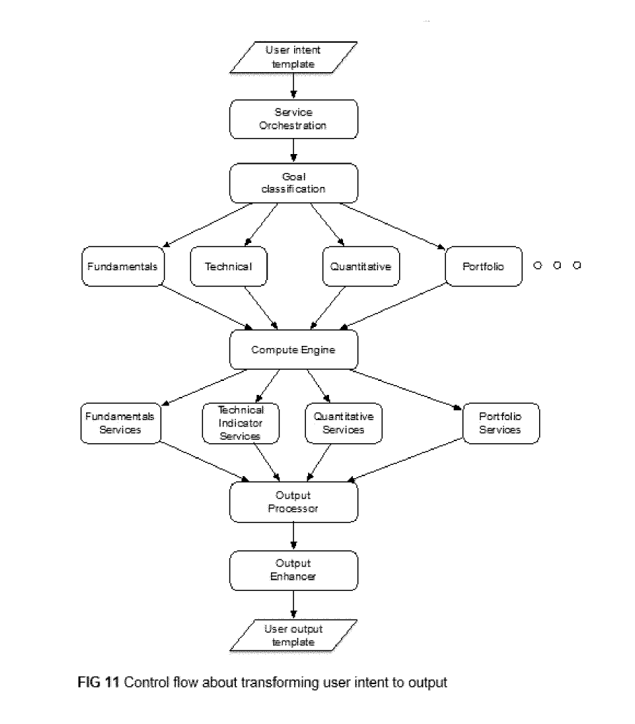

FIG. 12 illustrates concept based searching. It maps various financial world concepts and themes, thereby allowing users to search based on financial concepts, measures, people, and companies.

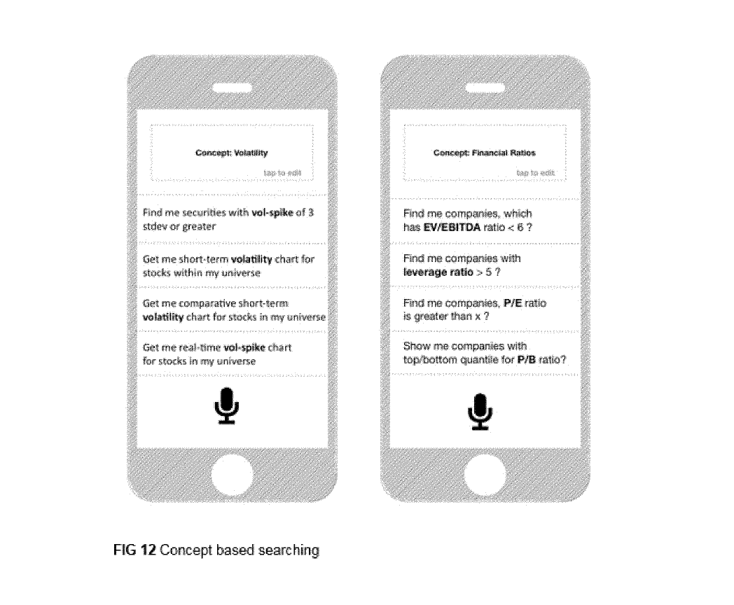

FIG. 13 allows users to keep-up with updates about the topics they're interested in by demonstrating interest in events, topics, companies and financial measures.

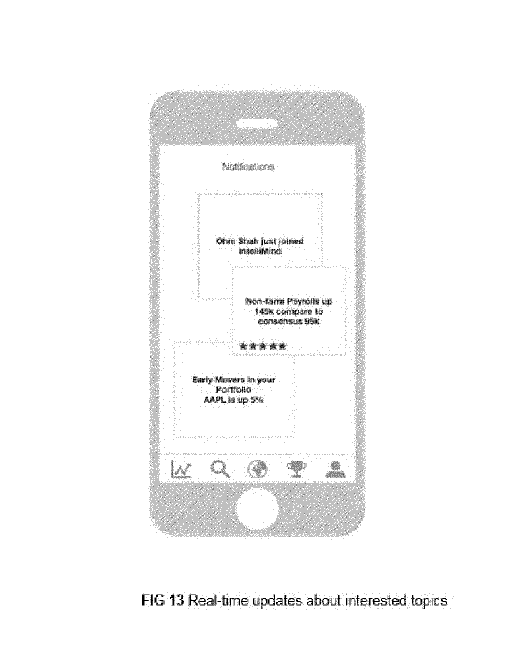

FIG. 14 illustrates predictive capability of the system. It takes into input various financial measures, historical and real-time price feed, historical weights to predict financial measures.

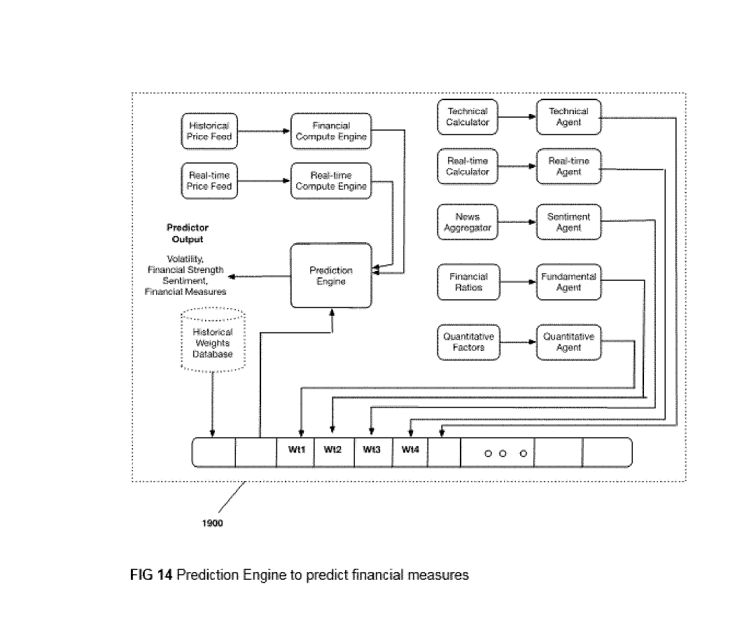

FIG. 15 illustrates strategy backtester component of the system. It takes into account various financial measures, historical and real-time price feed and evaluates strategy or idea's soundness with respect to profitability, consistency and edge within particular marketplace.

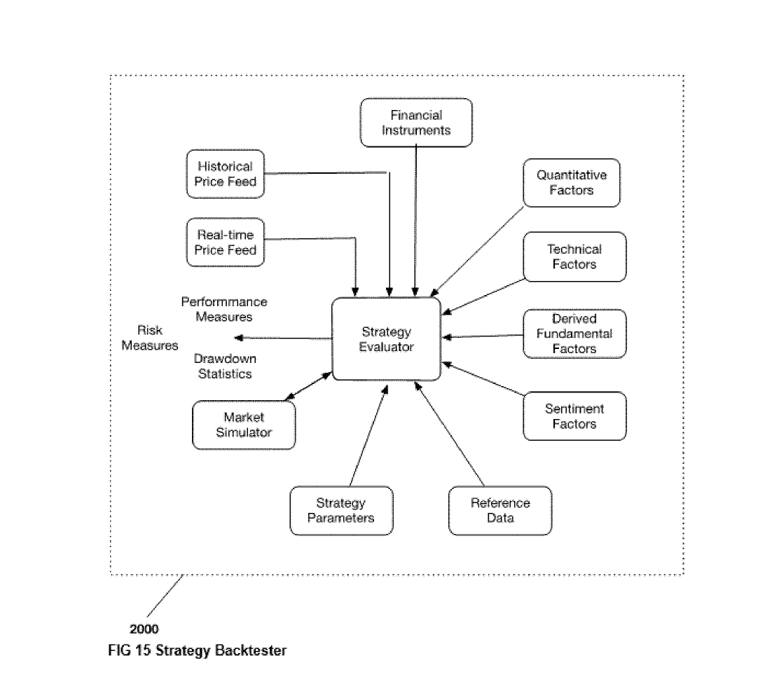

FIG. 16 illustrates asset allocation engine component of the system. Based on user's financial profile, portfolio holdings, Historical asset class performance, Risk Evaluation Engine and Asset allocation models, the Asset Allocation Engine comes up with recommended choices of portfolios for user.

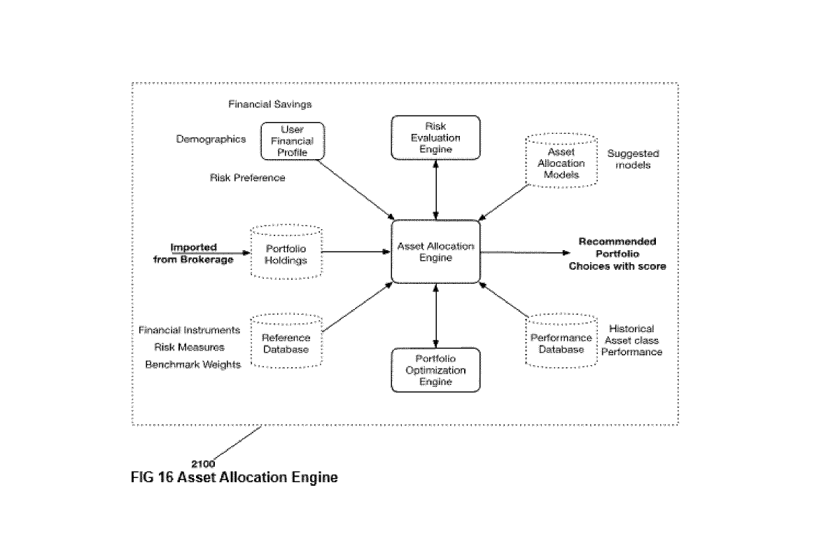

FIG. 17 illustrates component, which allows automated pattern detection, evaluation and taking action on behalf of user. Based on user's preferences and stand-by instructions the system can act on behalf of user to take necessary action.

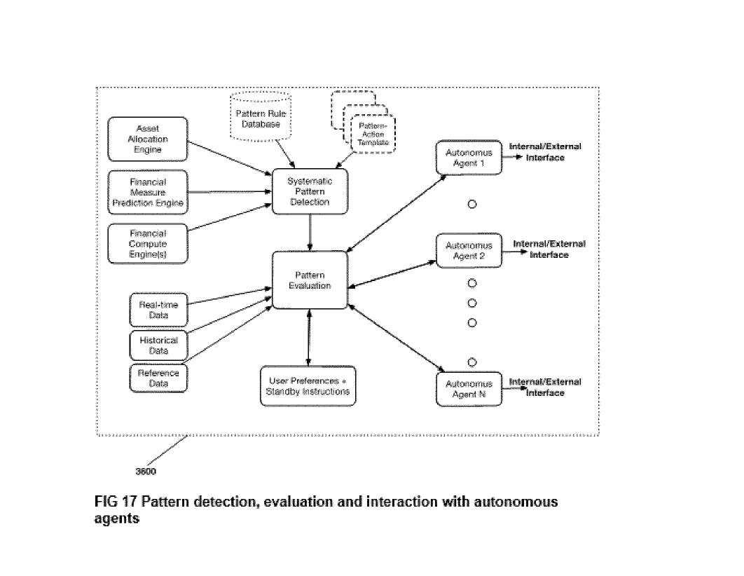

FIG. 18 illustrates component, which allows automated news scrapping, aggregation, classification and recommendation to user based on derived behavioral patterns, user's portfolio/watch list and past ratings.

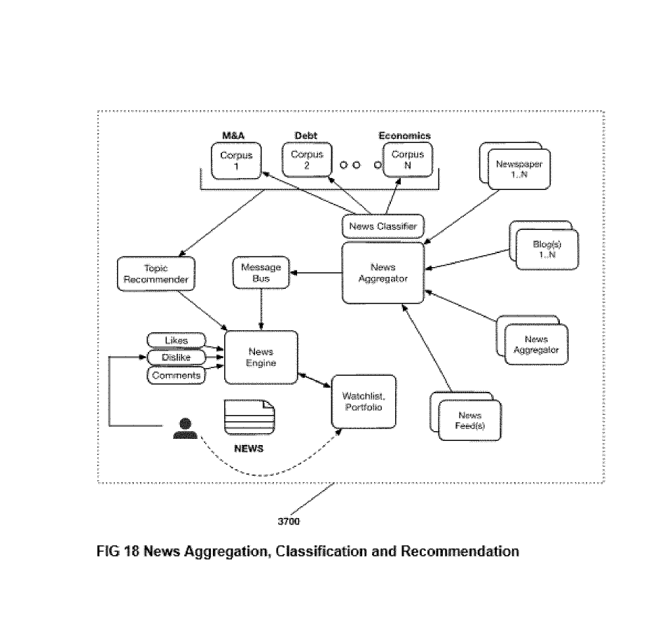

FIG. 19 illustrates overall interaction of Intelligent Financial Assistant with world entities. Based on historical knowledge graph, real-time financial market snapshot, coupled with asset allocation engine, semantic engine, strategy backtester and many similar components the Intelligent Assistant serves wide user base with roles such as Portfolio Manager, Financial Advisor, Risk Manager, Trader, and even entire investor community.

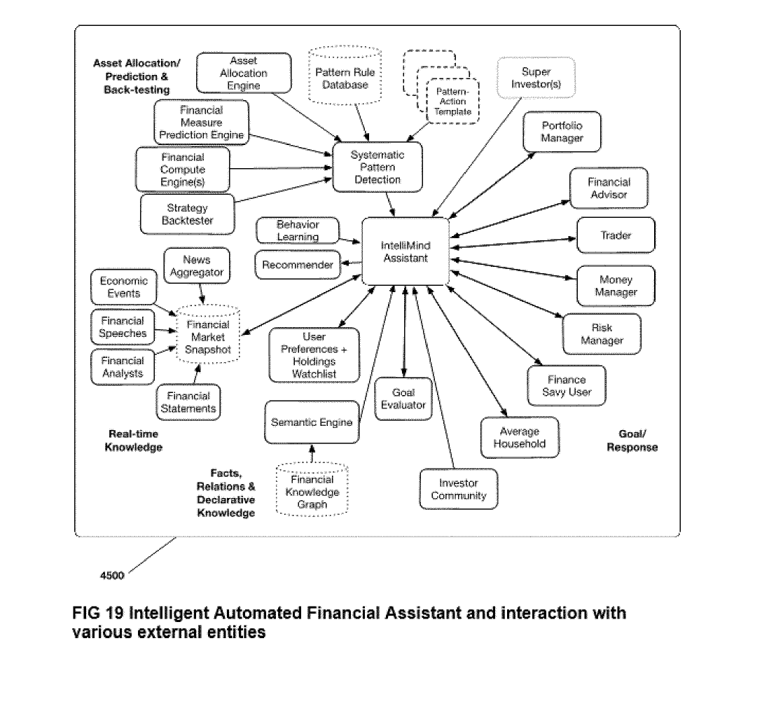

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “in communication with” or “connected to” another element or part, then it can be directly in communication with or connected to the other element or part, or intervening element(s) or part(s) may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

The system and method disclosed herein may comprise one or more computers or computerized elements, in communication with one another, working together to carry out the different functions of the system. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system and method disclosed herein may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP). In some embodiments, the network may comprise a cellular telephone network configured to enable exchange of data including, but not are not limiting to, textual data, audio data, video data, or any combination thereof.

The system for providing personalized financial recommendation may be implemented in hardware or a suitable combination of hardware and software. In some embodiments, the system may be a hardware device including processor(s) executing machine readable program instructions for analyzing data, and interactions between the components of the system. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the system for performing tasks such as signal coding, data processing input/output processing, power control, and/or other functions. The system may include modules as software units executing on a processor.

The system may include, in whole or in part, a software application working alone or in conjunction with one or more hardware resources. Such software applications may be executed by the processor(s) on different hardware platforms or emulated in a virtual environment. Aspects of the system, disclosed herein, may leverage known, related art, or later developed off-the-shelf software applications. Other embodiments may comprise the system being integrated or in communication with a mobile switching center, network gateway system, Internet access node, application server, IMS core, service node, or some other communication systems, including any combination thereof. In some embodiments, the components of system may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

The system may include a variety of known, related art, or later developed interface(s) (not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both.

All descriptions are for the purpose of showing selected versions of the present invention and are not intended to limit the scope of the present invention.

The present invention is an intelligent automated financial assistant. The system adapts and provides dynamic view based on user's demographics, preferences and financial information. It has an active learning component, which tracks user's behavior, feedback rating to various components and activity matrix to learn about user, role transition and surroundings.

The system heavily employs various financial, analytical and quantitative engines to serve the user based on their needs. Some of the functionality is powered by external services with which system can interact.

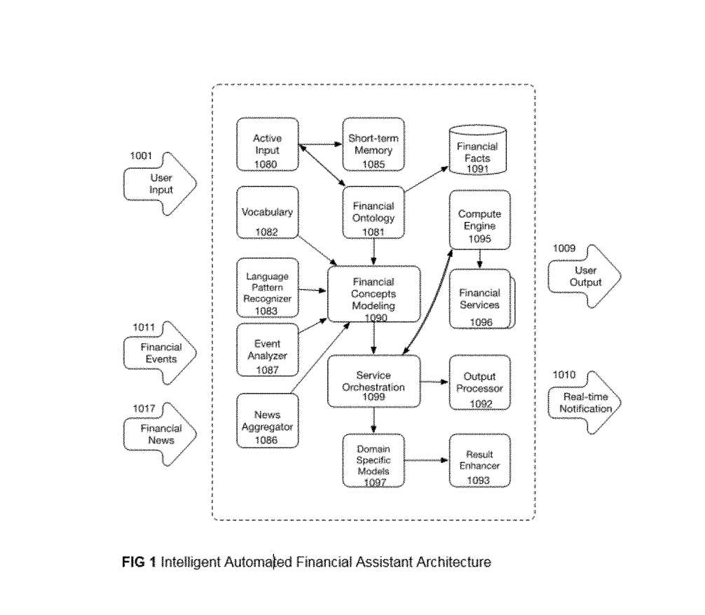

System Architecture—Referring now to FIG. 1, there is shown a simplified block diagram of a specific example embodiment of an intelligent financial assistant 1008. As described in greater detail herein, different components of intelligent financial automated assistant systems may be configured, designed, and/or operable to provide various different types of operations, functionalities and/or features generally relating to intelligent automated financial assistant technology.

1080 enable the operation of application and services via natural language dialog that are otherwise provided by dedicated applications with graphical user interfaces

1081 consists of financial ontology, which maps the financial world concepts including People, Places, Institutes, Instruments, Indices, various agents such as Financial Advisor, Brokers, Portfolio Manager, etc. . . . It continuously expands the ontology as it collects new knowledge from the financial domain.

1082 consists of financial vocabulary including products, financial measures, legendary investors, and company names, quantitative concepts used in model building. It also includes various synonyms to disambiguate various used concepts.

1083 The Language Pattern Recognizer identifies key concepts/themes within goal based on 1081 Financial Ontology and 1082 Vocabulary. It allows tagging the sentence parts for better understanding user intent and helps to convert into intent template.

1085 It keeps track of most recently inputted goals and parse trees. Also, it allows to track user's recent behavior.

1086 The News Aggregator aggregates news from various structured and unstructured disparate media sites. Once retrieved, it generates aggregated summary based on specific time interval.

1087 It allows analyzing events such as Earnings, Split, M&A, as well as various economic events such as Nonfarm payroll, Oil inventory and Nat Gas inventory.

1090 It uses multiple domain specific models to transform user intent into meaningful template with input, output, asset class and constraints. It uses semantic knowledge graph to enrich overall template.

1093 offers personal recommendations for asset allocation, trade ideas, news stories, or any other type of recommendation service that benefits from interactive dialogue and automated access to derived data and value-add services.

1095 plays crucial role in calculating various intermediate and final indicators such as technical, quantitative, sentiment as well as fundamental.

1096 These actionable steps are otherwise provided by dedicated applications with graphical user interfaces including (asset allocation recommendation); trade idea recommendation (such as particular trade may allow one to capture short-term alpha); getting real-time news about stocks in watch list (getting news stories about stocks within your holdings); monitor performance (evaluate performance of your investment compare to benchmark); obtain sentiment score (get sentiment score for securities within your portfolio); follow legendary investors (learn from behavior of legendary investors such as Warren Buffet).

1099 It plays central role in transforming template generated by 1090 to actionable steps that can be carried out by Compute Engine 1091.

Additionally, various embodiments of assistant 1008 described here may include or provide number of different advantages and/or benefits over currently existing intelligent financial assistant technology such as, for example, one or more of the following (or combinations thereof):

1083 and 1097: the integration of speech-to-text and natural language understanding technology that is constrained by a set of explicit financial domain specific models, tasks, services and dialogs. Unlike generic assistant technology that attempts to implement a general-purpose financial intelligence system the embodiments described here.

1090 The ability to solve user's financial problems by invoking services on their behalf overall requires financial knowledge graph, deep financial modeling, and overall inter-market financial relationship.

1085 better interpretation of user input (e.g. using personal selection, recent goals)

1093 personalized results (e.g. personalize results based on personal risk preferences, demographics and recent user behavior/feedback)

1011 The system captures various economic events as well as events such as Earnings, Earnings transcripts, Split, M&A, other similar financial events and Speech from FOMC members.

1017 The News Aggregator gathers news feeds, news from various sources. It than performs semantic analysis on these News Feeds to identify and extract key information such as people, places, companies, instruments, events and various interactions among these entities.

1009 The transformed output contains different type of output based on input goal, domain specific models and natural language understanding. The output can be a chart, table, free-text with annotations and/or voice-guided output.

1010 Based on real-time subject updates such as market, signal, person or social feed the system generates real-time notification.

1900 Based on real-time price feed, historical price feed, historical weights as well as various derived factors from agents such as Sentiment, Real-time, Fundamental, etc. . . . the Prediction engine predicts outcome for various financial measures. This measures cover wide array of financial instruments and sectors.

2000 Based on various financial measures and real-time computations, it allows one to quickly evaluate soundness of their idea with respect to profitability, consistency and edge within marketplace.

3600 Based on various predicted financial measures, historical, real-time and reference data as well as various financial compute engines, it automatically detects patterns in market place and interacts with pattern evaluation as well as autonomous agents to carry out instructions on behalf of user.

According to various embodiments of the present invention, intelligent financial assistant systems may be configured, designed and/or operable to provide different type of financial assistance which can otherwise not possible without deep financial expertise.

At the heart of the system is composed of key components. These components include Semantic Engine, Financial Compute Engine, Financial Measure Prediction Engine and Recommendation Engine.

The Semantic Engine is powered by Semantic database and Knowledge graph to automatically analyze various structured and unstructured information. It automatically analyzes Financial News Feeds, News Stories, Speech by Federal Open Market Committee members and other real-time sources to serve user based on user's interests and behavior. At the same time, it analyzes user's intent to dynamically generate response accordingly.

The Financial compute engine, with the help of domain specific models which dynamically understands the financial instrument; subjects, financial measures and can compute quantitative measures in the environmental context. These measures can be further post-processed to tailor user's needs.

The Financial Measure Prediction engine takes input from various other autonomous agents such as News Sentiment, Technical, Quantitative, Fundamental agent as well as historical and real-time price feed. Considering weights to various historical factors as well as real-time factors the prediction engine predicts output, which can aid into future outcome.

The Recommendation engine learns from user community, user's preferences, past behavior and based on user's persona, it offers targeted recommendation for high impact.

The Strategy backtester allow user to quickly evaluate soundness of financial idea/strategy to ensure their profitability.

The intelligent financial assistant integrates a variety of capabilities provided by different software components such as (e.g. Natural Language Recognition, Personal demographics, User's investment information, Household information and past behavior)

The intelligent financial assistant categorizes goals based on their temporal differences and classifies them into following categories such as instantaneous, real-time, short-term and long-term. Based on such classification, it first retrieves relevant datasets. It instantiates various financial calculators based on subject to compute derived measures. It than present, these measures as a chart, table with comparative top/bottom quintiles or as annotated text.

Each goal can be categorized among various categories by financial concepts such as Credit, Debit, Earnings, Economic events, etc. . . . Based on concept, it will utilize active ontology to generate appropriate goal template. The service orchestration takes goal template as input and invokes appropriate service thereby invoking financial compute engine. The Financial compute engine uses appropriate financial calculator to calculate financial measure. The output processor than takes the financial measure output and transforms it based on goal template. In some cases, it translates measure to chart whereas in others it translates measure to top/bottom quintile.

The Financial News Aggregator aggregates News Feeds from various sources at pre-determined window to compute aggregate sentiment, modality, concentration and novelty measures for each instrument. It than associates these measure together with financial measures such as momentum and volatility. In parallel, it also performs semantic analysis of these stories to extract People, Places, Securities and Companies.

At the heart of all of the components is Semantic Knowledge Graph, which relates various Companies, People, Places, Products and various related facts together.

As a result, the intelligent assistant leverages Real-time News, Real-time prices, Historical prices and Semantic Knowledge Graph to answer various questions. These questions can't be answered from pure facts, as it requires relationship extraction, deriving knowledge and real-time computation of financial measures.

Even though, process steps, algorithms or the like may be described in a sequential order, such process steps and/or algorithms may be configured to work in alternate orders or in parallel. In other words, any sequence or order of steps that my be described in this patent application does not, in and of itself, indicate a requirement that these steps be performed in any defined order.

For example, the user may input goal to assistant 1080 such as “Find me stocks which received highest Money Flow within last two weeks”. Once assistant 1008 determine the user's intent, using the techniques described herein, assistant 1008 can call external services 1004 to interface with price feed from exchange. Assistant 1008 get price data on behalf of user. The assistant thereby leverages concept modeler 1090 to learn about Money Flow concept. As a result, it eventually utilizes appropriate Financial Compute Engine 1095 to generate appropriate template. This template can be utilized by financial services 1096 to compute Money Flow based on various temporal conditions before presenting it to user. This way, the user can use assistant 1008 as a replacement for conventional mechanisms to obtain data, performing analysis and generating final result. If user's requests are ambiguous or need further clarification assistant 1008 can use the various techniques described here in, including active input 1080, paraphrasing and suggestions to refine the needed information from user before acting on it. In this process, assistant may ask user to confirm the entered goal or request to validate the assumptions made.

To further illustrates capabilities; for example, the user may provide assistant 1080 to leverage capabilities within 3600 by preferences or stand-by instructions such as liquidate 10% of my portfolio when market drops by 5%. In this scenario, the autonomous integrates with Brokerage services can automatically take necessary action on behalf of user in an automated fashion.

The invention distinguishes itself from other similar inventions by embedding deep financial subject matter knowledge and active learning techniques. This allows intelligent automated financial assistant to dynamically adapt to new information and utilize it to generate more precise results considering current snapshot of the world markets. In addition, the key component, which further distinguishes itself from competitors, is automated pattern detection, evaluation and automated action based on user preferences.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. An intelligent automated financial assistant operating on a computing device, the assistant comprising:
an input device, for receiving user input;
a language interpreter component, for interpreting the received user input to derive a representation of user intent;
a financial dialog flow processor component, for identifying at least one of the financial sub-domain, at least one task, and parameters/constraints for the task;
a financial services orchestration component, for calling internal compute engine for performing the identified task; and
an output processor component, for rendering output based on data received from the compute engine.

2. The automated financial assistant of claim 1, further comprising:
an active elicitation component for “capturing user intent” from a user via conversational interface; and
an active financial ontology, comprising representations of financial concepts, and relationships among various related concepts.

3. The automated financial assistant of claim 1, further comprising a financial vocabulary database, comprising associations between words and financial concepts; and wherein at least one of the language interpreter component, the financial dialog flow processor component, the service orchestration component, and the output processor component interfaces with the financial vocabulary database.

4. The automated financial assistant of claim 1, further comprising:
a financial domain entity database, comprising data from financial sub-domains such as quantitative finance, technical finance, fundamentals as such to capture declarative knowledge or various entities within financial domain, wherein at least one of the language interpreter component, the financial dialog flow processor component, the service orchestration component, and the output processor component interfaces with the domain entity model.

5. The automated financial assistant of claim 1, further comprising:
a goal classification engine, which automatically classifies goal and correctly captures user intent, wherein the goal classification engine interfaces with service orchestration component to fine-tune user goal and activating related financial compute engine.

6. The automated financial assistant of claim 1, wherein the service orchestration component at least invokes one of the financial compute engine to carry out necessary computation.

7. The automated financial assistant of claim 1, wherein the service orchestration component receives the output from financial compute engine, and the financial compute engine invoking multiple other services such as price feed gathering, reference data retrieval, real-time news analysis and/or retrieving other data from internet based on goal concepts.

8. The automated financial assistant of claim 1 wherein the service orchestration component receives the output from financial compute engine and unifies results received and performs further aggregation/analysis of datasets.

9. The automated financial assistant of claim 1, wherein the output processor component augments user intent and generates final output for presentation. The output can be complex graph, heat map, text with annotations, or can be a tabular format.

10. The automated financial assistant of claim 1, wherein the output enhancer component interfaces with output processor to enhance output by adding recommendations/suggestions for enhanced user experience.

11. That automated financial assistant of claim 1, wherein the assistant operates on at least one of the form
a smartphone;
a tablet computer; and
a desktop computer.

12. That automated financial assistant of claim 1, further comprising a Financial Compute Engine, which not only understands various financial concepts and related calculations for derived data but also understands various compute algorithms applicable to make meaningful sense of derived result.

13. That automated financial assistant of claim 1, further comprises an Asset Allocation Engine one type of compute engine, which analyzes user's demographics, current asset allocation and related goals to come up with optimal choice for user pertaining to specific goal.

14. That automated financial assistant of claim 1, further comprising an Event Analyzer, which automatically extracts various financial events such as earnings, split, guidance as well as various economic events to present user with a summarized result.

15. That automated financial assistant of claim 1, further comprises a News Aggregation Engine, which automatically extracts news facts, understands semantic concepts, their positive/negative impact on various subjects presented within news. It also analyzes potential impact on peer group.

16. A computerize method for implementing automated financial assistant, using a computer comprising a memory and a processor, the method comprising the steps of:
identifying user's financial/investment intent;
interpreting user's intent within financial domain;
orchestrating user's intent and relating it to various financial concepts, financial entities and meaningful conceptual representation;
activating particular financial compute engine to carry out series of computations to generate meaningful output;
transforming output to generate desired output for user;
enhancing output to provide rich user experience with potential recommended/suggested actions; and
rendering output to user.
